(19) United States
(12) Patent Application Publication
(10) Pub. No.: US 2016/0003452 A1
(43) Pub. Date: Jan. 7, 2016

(54) Surface Light-Emitting Unit

(71) Applicant: KONICA MINOLTA, INC., Chiyoda-ku, Tokyo (JP)

(72) Inventors: Yusuke HIRAO, Takatsuki -shi, Osaka (JP); Nobuya MIKI, Ibaraki -shi, Osaka (JP); Yasuhiro SANDO, Amagasaki -shi, Hyogo-ken (JP)

(21) Appl. No.: 14/772,631

(22) PCT Filed: Jan. 17, 2014
(86) PCT No.: PCT/JP2014/050760

§ 371 Date: Sep. 3, 2015

(30) Foreign Application Priority Data
Mar. 4, 2013 (JP) 2013-041815

(51) Int. Cl. F21V 13/04

(52) U.S. Cl. CPC F21V 13/04; F21Y 2105/008

(57) ABSTRACT

A surface light-emitting unit includes light-emitting panels, a reflective member for reflecting part of light emitted from the light-emitting panels toward the front side, a first diffusion plate arranged so as to be opposed to the light-emitting panels and the reflective member at a distance therefrom, and a second diffusion plate positioned on the opposite side to the light-emitting panels as viewed from the first diffusion plate for diffusing light from the first diffusion plate.

### CROSS REFERENCE TO RELATED APPLICATIONS

This is the U.S. national stage of application No. PCT/JP2014/050760, filed on Jan. 17, 2014. Priority under 35 U.S.C. §119(a) and 35 U.S.C. §365(b) is claimed from Japanese Application No. 2013-041815, filed Mar. 4, 2013, the disclosure of which is also incorporated herein by reference.

### TECHNICAL FIELD

The present invention relates to a surface light-emitting unit including a light-emitting panel.

### BACKGROUND ART

In recent years, surface light-emitting units including light-emitting panels as light sources have drawn attention. Surface light-emitting units are not limited to lighting systems but are used as back lights for liquid crystal displays, calculator monitors, and outdoor advertisements (signage or internally illuminated signs). In general, surface light-emitting devices such as organic electro luminescence (EL) devices are used for light-emitting panels.

In light-emitting panels, a non-emission portion of a surface light-emitting device is formed around an emission portion in order to seal the emission portion or to connect the emission portion with wiring. When an organic EL device is used as a surface light-emitting device, the surface light-emitting device includes a transparent electrode and a reflective electrode to allow current to flow through a light-emitting layer, wherein a non-emission portion is formed on the outer periphery of an emission portion in order to secure a space for connecting bonding wires to the transparent electrode and the reflective electrode.

Japanese Laid-Open Patent Publication No. 2006-156205 (PTD 1) discloses an invention related to a light-emitting device. This light-emitting device includes a light-emitting panel and a reflective member shaped like a triangle in cross section and arranged in a non-emission portion of the light-emitting panel. According to this publication, the light-emitting device can improve the brightness in the front direction at the non-emission portion and the periphery thereof.

### CITATION LIST

### Patent Document

### PTD 1: Japanese Laid-Open Patent Publication No. 2006-156205

### SUMMARY OF INVENTION

### Technical Problem

The present invention aims to provide a surface light-emitting unit in which non-uniformity of brightness can be reduced.

### Solution to Problem

A surface light-emitting unit according to an aspect of the present invention includes: a plurality of light-emitting panels arranged side by side in a planar state; a reflective member having a shape extending along outer edges of the light-emitting panels adjacent to each other among a plurality of the light-emitting panels for reflecting part of light emitted from a plurality of the light-emitting panels toward a front side; a first diffusion layer arranged so as to be opposed to a plurality of the light-emitting panels and the reflective member at a distance therefrom for diffusing light emitted from a plurality of the light-emitting panels and light reflected by the reflective member; and a second diffusion layer positioned on an opposite side to a plurality of the light-emitting panels as viewed from the first diffusion layer and arranged at a distance from the first diffusion layer for diffusing light from the first diffusion layer.

### Advantageous Effects of Invention

The configuration described above can further reduce non-uniformity of brightness.

### BRIEF DESCRIPTION OF DRAWINGS

FIG. 1 is a perspective view of a surface light-emitting unit in an embodiment.

FIG. 2 is a cross-sectional view as viewed from the arrows II-II in FIG. 1.

FIG. 3 is a cross-sectional view of the surface light-emitting unit in the embodiment in a driven state.

FIG. 4 is a cross-sectional view of the surface light-emitting unit in the present embodiment applied to an internally illuminated sign.

FIG. 5 is a cross-sectional view of a surface light-emitting unit in a modification to the embodiment.

FIG. 6 is a cross-sectional view of a surface light-emitting unit in Comparative Example.

FIG. 7 illustrates the characteristics of diffusion sheets used in experimental examples.

FIG. 8 shows experimental conditions for Examples 1 to 5 in the experimental examples.

FIG. 9 is a graph showing experiment results (diagonal brightness profile) according to Examples 1 to 5 and Comparative Example in the experimental examples.

FIG. 10 is a graph showing experiment results (frontward brightness profile) according to Examples 1 to 5 and Comparative Example in the experimental examples.

### DESCRIPTION OF EMBODIMENTS

Embodiments and examples based on the present invention will be described below with reference to the figures. The scope of the present invention is not necessarily limited to the numbers and the quantities mentioned in the description of embodiments and examples, if any, unless otherwise specified. In the description of embodiments and examples, the same parts and the corresponding parts are denoted with the same reference numerals and an overlapping description may not be repeated.

### Embodiments

### Surface Light-Emitting Unit 1

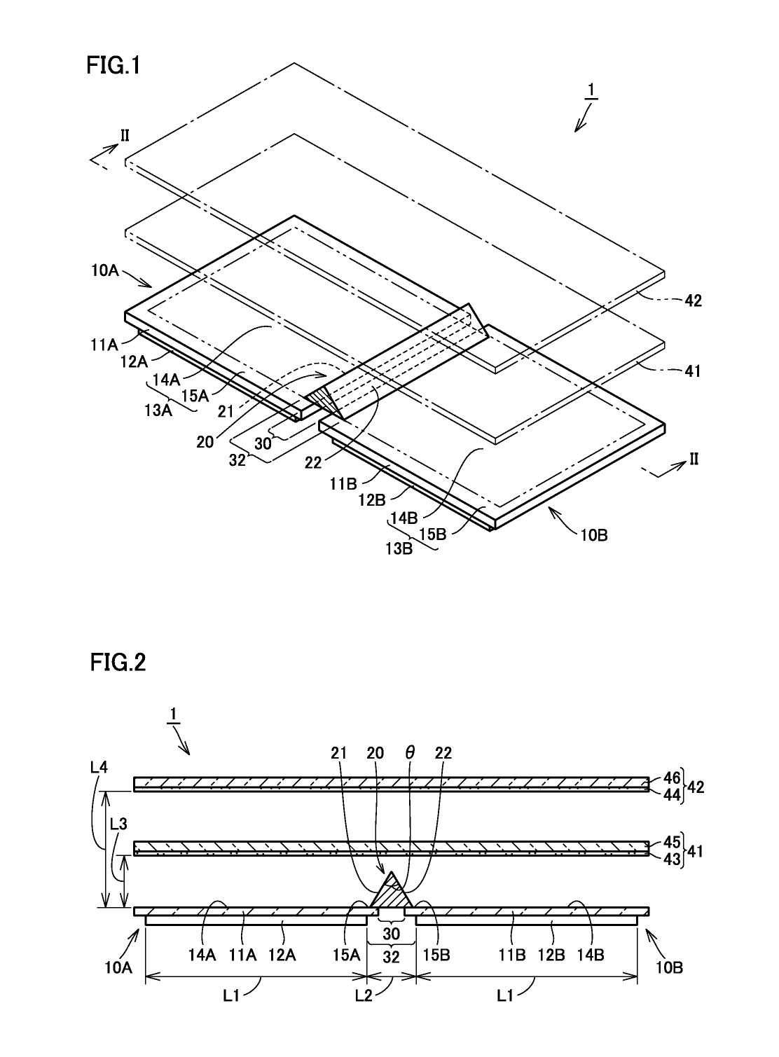

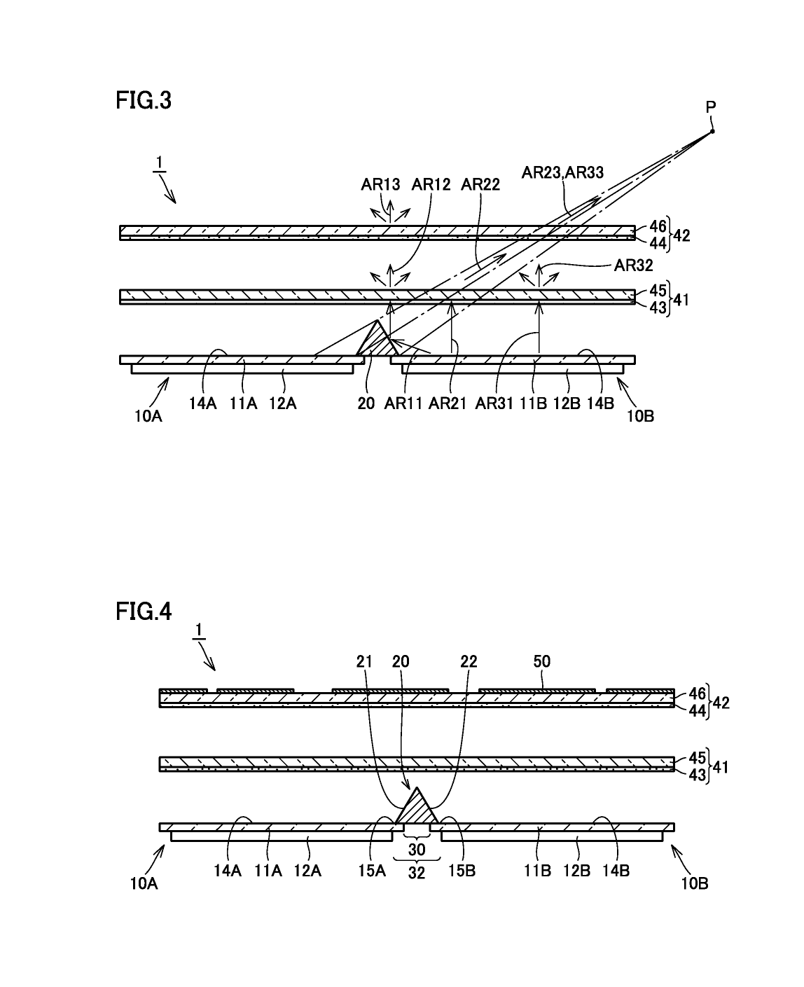

Referring to FIG. 1 to FIG. 3, a surface light-emitting unit 1 in an embodiment will be described. FIG. 1 is a perspective view of surface light-emitting unit 1. FIG. 2 is a cross-sectional view taken along the arrows II-II in FIG. 1. FIG. 3 is a cross-sectional view of surface light-emitting unit 1 in a driven state.

As shown in FIG. 1 and FIG. 2, surface light-emitting unit 1 includes light-emitting panels 10A, 10B, a reflective member 20, a first diffusion plate 41, and a second diffusion plate 42. In FIG. 1, first diffusion plate 41 and second diffusion plate 42 are shown in a see-through view using alternate long and short dashed lines, for the sake of convenience.

Light-emitting panels 10A, 10B, reflective member 20, first diffusion plate 41, and second diffusion plate 42 are fixed to a not-shown casing. Light-emitting panels 10A, 10B are arranged on the back side of the casing. Second diffusion plate 42 is arranged on the front side of the casing. First diffusion plate 41 is arranged between light-emitting panels 10A, 10B and second diffusion plate 42.

(Light-Emitting Panels 10A, 10B)

Light-emitting panels 10A, 10B each have a flat plate-like shape extending in the plane direction. Light-emitting panels 10A, 10B are arranged such that respective light-emitting surfaces 13A, 13B (see FIG. 1) are side by side in a planar state. Surface light-emitting unit 1 may further include a plurality of light-emitting panels, in addition to light-emitting panels 10A, 10B, arranged in row and column directions in a planar state. Light-emitting panels 10A, 10B include transparent substrates 11A, 11B and emitters 12A, 12B, respectively, having organic EL devices (not shown).

Transparent substrates 11A, 11B are formed with an insulating material that well transmits light in the visible light region. Emitters 12A, 12B are formed on the surface of transparent substrates 11A, 11B on the opposite side to light-emitting surfaces 13A, 13B. Examples of transparent substrates 11A, 11B used include glass plates, plastic plates, polymer films, silicon plates, and laminated plates thereof, in view of light transmissivity. Transparent substrates 11A, 11B may be either rigid substrates or flexible substrates.

Emitters 12A, 12B each have a flat plate-like shape extending along the plane direction. Emitters 12A, 12B each include a transparent electrode layer, an organic electroluminescence layer, and a reflective electrode layer, and are arranged on the back side of transparent substrates 11A, 11B. Light-emitting panels 10A, 10B in the present embodiment are light-emitting panels comprised of bottom emission-type organic EL devices.

Light-emitting panels 10A, 10B may be light-emitting panels comprised of top-emission-type organic EL devices, or light-emitting panels comprised of a plurality of light-emitting diodes and a diffusion plate arranged on the exit surface side (front side) of the light-emitting diodes, or light-emitting panels using cold cathode ray tubes and the like.

Light-emitting panels 10A, 10B are arranged adjacent to each other at a distance (gap 30) from each other. The provision of gap 30 between light-emitting panels 10A and 10B can increase the light-emitting area as a light source when compared with the arrangement of light-emitting panels 10A, 10B in contact with each other without gap 30. Light-emitting panels 10A, 10B may be arranged such that transparent substrate 11A and 11B are in contact with each other.

Light-emitting panels 10A, 10B have light-emitting surfaces 13A, 13B (see FIG. 1). Light-emitting surfaces 13A, 13B are formed with the outer surfaces of transparent substrates 11A, 11B that are positioned on the opposite side to the side where emitters 12A, 12B are positioned. As described above, light-emitting panels 10A, 10B are arranged such that light-emitting surfaces 13A, 13B are side by side in a planar state. Light-emitting panels 10A, 10B in the present embodiment are arranged such that light-emitting surfaces 13A, 13B are positioned on the same plane.

Light-emitting surfaces 13A, 13B have emission regions 14A, 14B emitting light and non-emission regions 15A, 15B positioned on the outer periphery of emission regions 14A, 14B. Emission regions 14A, 14B each have a rectangular shape. In the direction in which light-emitting panels 10A, 10B are arranged (the left-right direction in the drawing sheet of FIG. 2), emission regions 14A, 14B each have a width L1 (see FIG. 2). The width L1 of emission regions 14A, 14B generally corresponds to the width of emitters 12A, 12B in the same direction. The width L1 is, for example, 90 mm.

Non-emission regions 15A, 15B each have a rectangular annular shape. Non-emission regions 15A, 15B are formed by providing a section for sealing the organic EL devices included in emitters 12A, 12B or connecting the organic EL devices with wiring. A section including gap 30 formed between adjacent light-emitting panels 10A and 10B and the non-emission regions of light-emitting panels 10A, 10B positioned adjacent to gap 30 constitutes a non-emission section 32.

Non-emission section 32 is a section that may cause darkness if no measures are taken. In the direction in which light-emitting panels 10A, 10B are arranged (the left-right direction in the drawing sheet of FIG. 2), non-emission section 32 has a width L2 (see FIG. 2). The width L2 is, for example, 10 mm.

### (First Diffusion Plate 41)

First diffusion plate 41 has a thin plate-like shape as a whole. First diffusion plate 41 is arranged on the front side (the side where light is emitted from light-emitting panels 10A, 10B) as viewed from light-emitting panels 10A, 10B and is opposed to light-emitting panels 10A, 10B and reflective member 20 as described later from the front side. First diffusion plate 41 in the present embodiment is fixed, for example, by a not-shown casing so as to have a positional relation parallel to light-emitting surfaces 13A, 13B of light-emitting panels 10A, 10B and is arranged spaced apart from light-emitting panels 10A, 10B with a distance L3 (see FIG. 2). The distance L3 is, for example, 22 mm.

First diffusion plate 41 (see FIG. 2) in the present embodiment includes a diffusion sheet 43 and a transparent substrate 45. Diffusion sheet 43 is provided on the surface of transparent substrate 45 on the light-emitting panels 10A, 10B side. Diffusion sheet 43 may be provided on the surface of transparent substrate 45 on the opposite side to the light-emitting panels 10A, 10B side. The thickness of diffusion sheet 43 is, for example, 100 μm.

Diffusion sheet 43 may be formed of a PET substrate in which diffusion beads (microparticles for light diffusion) are dispersed. A sheet member having a surface shaped like a micro-lens array (projections and depressions) may be used as diffusion sheet 43. Examples of transparent substrate 45 include a glass substrate, plastic (acrylic resin), a polymer film, a silicon plate, and a laminated plate thereof. The thickness of transparent substrate 45 is, for example, 2 mm to 3 mm.

First diffusion plate 41 in the present embodiment can function as a first diffusion layer that diffuses light passing through first diffusion plate 41. The configuration of the first diffusion layer is not limited to the configuration including diffusion sheet 43 and transparent plate 45 provided as different members. The first diffusion layer may be the one formed by providing projections and depressions for light diffusion (the one using interface reflection) on the surface of transparent substrate 45 per se or the one formed by dispersing microparticles for light diffusion in the inside of transparent substrate 45 per se (the one using internal scattering).

### (Second Diffusion Plate 42)

Second diffusion plate 42 also has a thin plate-like shape as a whole. Second diffusion plate 42 is arranged on the front side (the opposite side to the side where light-emitting panels 10A, 10B are positioned as viewed from first diffusion plate 41) as viewed from first diffusion plate 41. Second diffusion plate 42 is opposed to first diffusion plate 41 from the front side. Second diffusion plate 42 in the present embodiment is fixed, for example, by a not-shown casing so as to have a positional relation parallel to light-emitting surfaces 13A, 13B of light-emitting panels 10A, 10B and is arranged spaced apart from light-emitting panels 10A, 10B with a distance L4 (see FIG. 2). The distance L4 is, for example, 50 mm.

Second diffusion plate 42 (see FIG. 2) in the present embodiment includes a diffusion sheet 44 and a transparent substrate 46. Diffusion sheet 44 is provided on the surface of transparent substrate 46 on the first diffusion plate 41 side (the light-emitting panels 10A, 10B side). Diffusion sheet 44 may be provided on the surface of transparent substrate 46 on the opposite side to the first diffusion plate 41 side (the light-emitting panels 10A, 10B side). The thickness of diffusion sheet 44 is, for example, 100 μm.

Diffusion sheet 44 may be formed of a PET substrate in which diffusion beads (microparticles for light diffusion) are dispersed. A sheet member having a surface shape like a micro-lens array (projections and depressions) may be used as diffusion sheet 44. Examples of transparent substrate 46 include a glass substrate, plastic (acrylic resin), a polymer film, a silicon plate, and a laminated plate thereof. The thickness of transparent substrate 46 is, for example, 2 mm to 3 mm.

Second diffusion plate 42 in the present embodiment can function as a second diffusion layer that diffuses light passing through second diffusion plate 42. The configuration of the second diffusion layer is not limited to the configuration including diffusion sheet 44 and transparent substrate 46 provided as different members. The second diffusion layer may be the one formed by providing projections and depressions for light diffusion (the one using interface reflection) on the surface of transparent substrate 46 per se or the one formed by dispersing microparticles for light diffusion in the inside of transparent substrate 46 per se (the one using internal scattering).

The transmittance of first diffusion plate 41 (diffusion sheet 43) is preferably higher than the transmittance of second diffusion plate 42 (diffusion sheet 44). The quantity of light transmitted through first diffusion plate 41 and diffused by second diffusion plate 42 is increased. The Haze values of first diffusion plate 41 (diffusion sheet 43) and second diffusion plate 42 (diffusion sheet 44) are preferably 90% or more.

### (Reflective Member 20)

Reflective member 20 reflects part of light emitted from emission regions 14A, 14B of light-emitting panels 10A, 10B toward the front side without transmitting it. Reflective member 20 has a section extending like a rod and is arranged so as to correspond to non-emission section 32. The rod-like extending section of reflective member 20 is arranged along the outer edges of light-emitting surfaces 13A, 13B of adjacent light-emitting panels 10A, 10B.

The rod-like extending section of reflective member 20 is provided on light-emitting surfaces 13A, 13B of light-emitting panels 10A, 10B so as to extend over the outer edges of light-emitting surfaces 13A, 13B of adjacent light-emitting panels 10A, 10B and extend along these outer edges. Reflective member 20 is opposed to non-emission section 32 from the front side and is positioned on light-emitting surface 13A of light-emitting panel 10A and light-emitting surface 13B of light-emitting panel 10B.

More specifically, reflective member 20 is provided on light-emitting panel 10A and light-emitting panel 10B so as to extend over non-emission region 15A (see FIG. 2) positioned at the outer edge on the light-emitting panel 10B side of light-emitting surface 13A of light-emitting panel 10A and non-emission region 15B (see FIG. 2) positioned at the outer edge on the light-emitting panel 10A side of light-emitting surface 13B (see FIG. 2) of light-emitting panel 10B (that is, reflective member 20 overlaps these non-emission regions 15A, 15B as viewed from the side where first diffusion plate 41 is positioned) and to extend along these non-emission regions 15A, 15B. Reflective member 20 is preferably fixed onto light-emitting surfaces 13A, 13B (transparent substrates 11A, 11B) using, for example, transparent adhesive for optical use (not shown).

The rod-like extending section of reflective member 20 has a triangular outer shape when viewed along the direction in which it extends, and includes a reflective surface 21 positioned on the light-emitting panel 10A side and a reflective surface 22 positioned on the light-emitting panel 10B side. The rod-like extending section of reflective member 20 may have a trapezoidal outer shape when viewed along the direction in which it extends.

Reflective surfaces 21, 22 are sections for reflecting light emitted from light-emitting surfaces 13A, 13B toward the front side (that is, toward the side where first diffusion plate 41 is positioned), each having a planar shape, and are arranged to intersect light-emitting surfaces 13A, 13B. The vertex angle 8 of reflective member 20 that is formed between reflective surfaces 21 and 22 is, for example, 50°.

Reflective member 20 is preferably formed of, for example, a metal material such as Al or a resin material. In this case, it preferable that the higher reflectivity at reflective surfaces 21, 22 should be better. The reflectivity of at least about 50% or more is generally preferred. The rod-like extending section of reflective member 20 may have a solid column-like shape as shown or instead may be a hollow tubular shape. In view of weight reduction, it is advantageous that the aforementioned section of reflective member 20 has a hollow tubular shape.

Reflective member 20 is fabricated by, for example, combining extruded metal materials, or folding a metal plate-shaped member by presswork, or injection molding of a resin material. Otherwise, a surface-polished stainless steel plate may be used as reflective member 20, or reflective member 20 may be formed with a white painted plate.

### (Operation and Effects)

Referring to FIG. 3, light produced by emitters 12A, 12B passes through the inside of transparent substrates 11A, 11B and is emitted from light-emitting surfaces 13A, 13B (emission regions 14A, 14B). Part of the light emitted from light-emitting surfaces 13A, 13B travels toward reflective member 20 and reaches reflective surfaces 21, 22 to be reflected (the arrow AR11).

Part of the light reflected by reflective surfaces 21, 22 enters first diffusion plate 41 at a portion corresponding to non-emission section 32 and the vicinity thereof and is then diffused by first diffusion plate 41 and emitted toward second diffusion plate 42 (the arrow AR12). The light is further diffused when passing through second diffusion plate 42 and emitted outward (the arrow AR13). Reflective member 20 is arranged so as to correspond to non-emission section 32, so that the brightness of light emitted from the portion of second diffusion plate 42 that corresponds to non-emission section 32 and the vicinity thereof can be increased to make non-emission section 32 inconspicuous, when compared with the case where reflective member 20 is not used.

Meanwhile, the other part of the light emitted from light-emitting surfaces 13A, 13B travels toward first diffusion plate 41 and enters first diffusion plate 41 (the arrows AR21, AR31). Part of the light incident on first diffusion plate 41 is diffused by first diffusion plate 401 and thereafter emitted toward second diffusion plate 42 (the arrows AR22, AR32). The light is further diffused when passing through second diffusion plate 42 and emitted outward. The light emitted outward includes light traveling toward a point P (the arrows AR23, AR33). The point P is any given position in a space positioned in the diagonal front direction in the direction in which light is emitted, relative to the direction vertical to light-emitting panels 10A, 10B.

In the present embodiment, the light emitted from light-emitting surfaces 13A, 13B is diffused when passing through first diffusion plate 41 and further diffused when passing through second diffusion plate 42. Suppose that the surface light-emitting unit includes only one of first diffusion plate 41 and second diffusion plate 42. In this case, the light emitted from light-emitting surfaces 13A, 13B is reflected toward the front side by reflective member 20 and thereafter emitted from the diffusion plate, or directly enters the diffusion plate to be emitted from the diffusion plate. This supposed configuration can reduce variations (uneven brightness) in brightness distribution of light emitted toward the front direction (the direction vertical to light-emitting panels 10A, 10B).

With this supposed configuration, however, it may be difficult to improve variations (uneven brightness) in brightness distribution in the diagonal direction (for example, the direction toward the point P) of light emitted from the diffusion plate, because of the presence of reflective member 20. For example, when surface light-emitting unit 1 is viewed in the diagonal direction from the position at the point P (see the alternate long and short dashed lines in the figure), a kind of shadow (darkness) partially darker than the neighborhood may appear on the surface of the diffusion plate due to the presence of reflective member 20. If such a surface light-emitting unit is used in lighting applications such as internally illuminated signs, the presence of such a dark shadow makes it difficult for users to visually recognize the characters or graphic patterns displayed on the internally illuminated signs.

By contrast, in surface light-emitting unit 1 in the present embodiment, the light emitted from light-emitting surfaces 13A, 13B is diffused when passing through first diffusion plate 41 and is further diffused when passing through second diffusion plate 42. Even when the light emitted from first diffusion plate 41 includes variations in brightness distribution of light in the direction toward the point P at the point of time when it is emitted from first diffusion plate 41, the light having variations passes through second diffusion plate 42, thereby reducing the degree of variations.

For example, not only light (the arrows AR21, AR22) traveling toward the point P as it is (traveling toward the point P even after passing through second diffusion plate 42), of the light diffused by first diffusion plate 41, but also light (for example, the arrow AR32) not traveling toward the point P of the light diffused by first diffusion plate 41 can be directed toward the point P (the arrow AR33) as being diffused by second diffusion plate 42. When compared with the configuration including reflective member 20 and first diffusion plate 41, the configuration including reflective member 20, first diffusion plate 41, and second diffusion plate 42 can increase the quantity of light (light directed in the diagonal direction) traveling toward the point P and the proximity thereof.

In surface light-emitting unit 1 in the present embodiment, reflective member 20 can reduce variations in brightness distribution in the front direction, and in addition, first diffusion plate 41 and second diffusion plate 42 can reduce variations in brightness distribution in the diagonal direction as well. Accordingly, non-uniformity of brightness of light emitted from surface light-emitting unit 1 can be reduced compared with conventional examples.

As described above, the transmittance of first diffusion plate 41 (diffusion sheet 43) is preferably higher than the transmittance of second diffusion plate 42 (diffusion sheet 44). The quantity of light transmitted through first diffusion plate 41 and diffused by second diffusion plate 42 is increased. Since light spreads radially, diffusing light at a position further from the light source can increase the effect of reducing uneven brightness. A high diffusion effect at second diffusion plate 42 can be achieved by introducing a larger quantity of light to second diffusion plate 42.

As described above, the Haze values of first diffusion plate 41 (diffusion sheet 43) and second diffusion plate 42 (diffusion sheet 44) are preferably 90% or more. The ability of first diffusion plate 41 (diffusion sheet 43) and second diffusion plate 42 (diffusion sheet 44) diffusing light is enhanced to facilitate diffusion or mixing of light passing therethrough. Accordingly, uneven brightness can be further reduced.

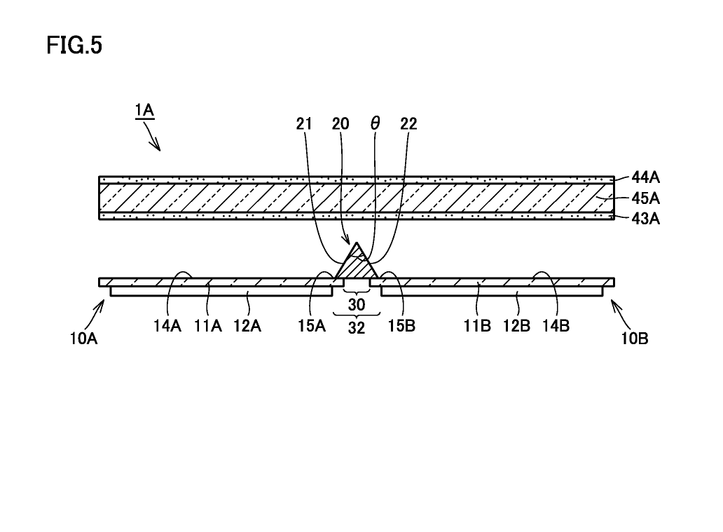

Referring to FIG. 4, when surface light-emitting unit 1 in the present embodiment is used, for example, in an internally illuminated sign, a sheet 50 having characters or graphic patterns formed thereon may be provided on the surface of transparent substrate 46 of second diffusion plate 42. Sheet 50 may be provided on the side of transparent substrate 46 or on the side of diffusion sheet 44. This internally illuminated sign can provide high recognition of the display content either when the internally illuminated sign is viewed from the front direction or when the internally illuminated sign is viewed from the diagonal direction, because not only variations in brightness in the front direction but also variations in brightness in the diagonal direction are reduced.

### (Modification)

FIG. 5 is a cross-sectional view of a surface light-emitting unit 1A in a modification to the embodiment. Surface light-emitting unit 1A includes a diffusion sheet 43A and a diffusion sheet 44A, and a transparent substrate 45A arranged therebetween.

Diffusion sheet 43A is provided on the surface (one surface) of transparent substrate 45A on the light-emitting panels 10A, 10B side. Diffusion sheet 43A has a sheet-like shape as a whole. Diffusion sheet 43A is arranged on the front side (on the side where light is emitted from light-emitting panels 10A, 10B) as viewed from light-emitting panels 10A, 10B and is opposed to light-emitting panels 10A, 10B and reflective member 20 from the front side.

Diffusion sheet 44A is provided on the surface (the other surface) of transparent substrate 45A on the opposite side to the light-emitting panels 10A, 10B side. Diffusion sheet 44A also has a sheet-like shape as a whole. Diffusion sheet 44A is arranged on the front side (the opposite side to the side where light-emitting panels 10A, 10B are positioned as viewed from diffusion sheet 43A) as viewed from diffusion sheet 43A. Diffusion sheet 44A is opposed to diffusion sheet 43A from the front side with transparent substrate 45A interposed.

In the present modification, diffusion sheet 43A can function as a first diffusion layer that diffuses light passing through diffusion sheet 43A, and diffusion sheet 44A can function as a second diffusion layer that diffuses light passing through diffusion sheet 44A. This configuration can achieve the same operation and effects as in the foregoing embodiment.

Diffusion sheet 43A and diffusion sheet 44A may be, for example, fixed to a casing in a state in contact with the surfaces of transparent substrate 45A. Alternatively, diffusion sheet 43A and diffusion sheet 44A may be integrally fixed to the surfaces of transparent substrate 45A by adhesive or any other methods. These configurations may be combined.

Also in this modification, the configuration as the first diffusion layer and the second diffusion layer is not limited to diffusion sheets 43A, 44A provided as separate members. The first diffusion layer may be the one formed by providing projections and depressions for light diffusion on the surface of transparent substrate 45A per se (the one using interface reflection) or the one formed by dispersing microparticles for light diffusion in the inside of transparent substrate 45A per se (the one using internal scattering). In this manner, the transparent substrate can be integrally configured so as to have a double layer including a transparent layer portion and a first diffusion layer portion (the portion having light diffusivity). The second diffusion layer may be the one formed by providing projections and depressions for light diffusion on the surface of transparent substrate 45A per se (the one using interface reflection) or the one formed by dispersing microparticles for light diffusion in the inside of transparent substrate 45A per se (using internal scattering). In this manner, the transparent substrate can be integrally configured so as to have a double layer including a transparent layer portion and a second diffusion layer portion (the portion having light diffusivity). When those configurations are employed in both of the first diffusion layer and the second diffusion layer, the transparent substrate can be configured to have a triple layer including a first diffusion layer, a transparent layer, and a second diffusion layer.

### Experimental Examples

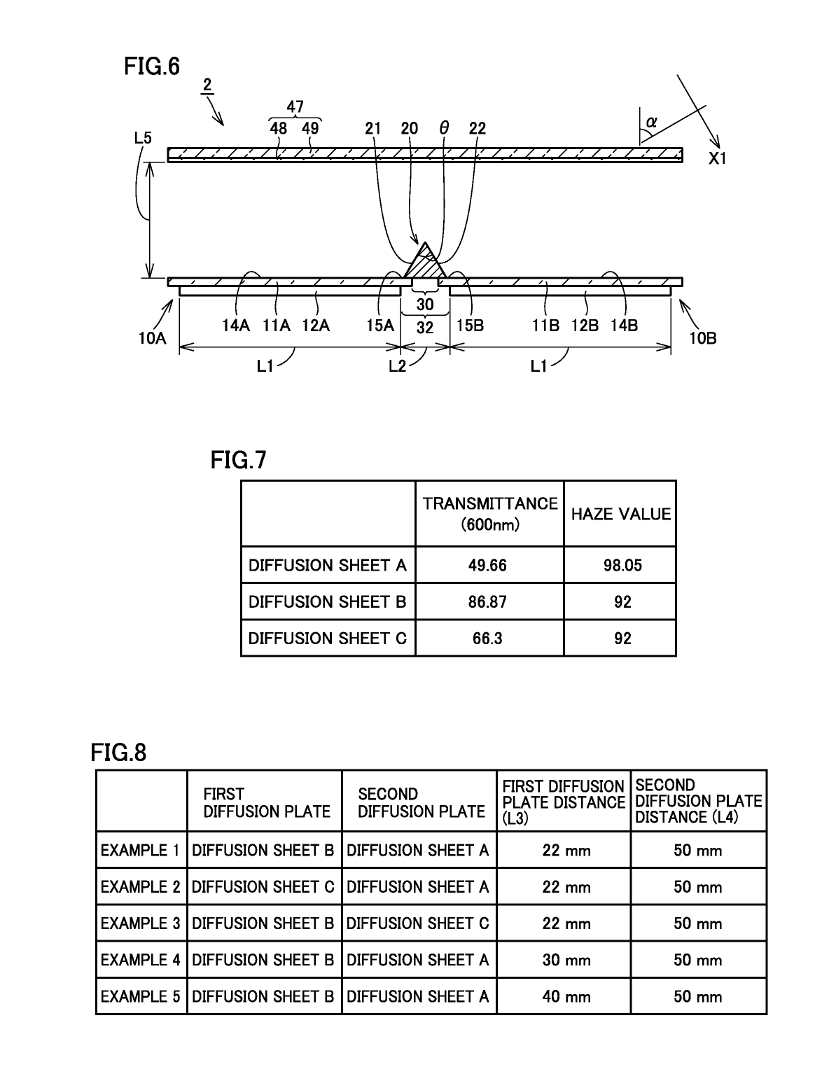

Referring to FIG. 6 to FIG. 10, experimental examples conducted in connection with the foregoing embodiment will be described. The experimental examples include Comparative Example (FIG. 6) and Examples 1 to 5 (see FIGS. 1 and 2) based on the embodiment.

Referring to FIG. 6, a surface light-emitting unit 2 in Comparative Example includes a single diffusion plate 47. Diffusion plate 47 includes a diffusion sheet 48 and a transparent substrate 49. The distance L5 (see FIG. 6) between diffusion plate 47 and light-emitting panels 10A, 10B is 50 mm. As for the properties of diffusion sheet 48 used in Comparative Example, the spectral transmittance for light having a wavelength of 600 nm is 49.66%, and the Haze value is 98.05%. The properties of diffusion sheet 48 used in Comparative Example are the same as those of diffusion sheet A used in Examples 1, 2, 4, and 5 described later (see FIG. 7, FIG. 8). The other configuration of surface light-emitting unit 2 is generally similar to surface light-emitting unit 1 used in Examples 1 to 5.

In each of the surface light-emitting units according to Examples 1 to 5 and Comparative Example, the width L1 (see FIG. 2, FIG. 6) of the emission portion of light-emitting panels 10A, 10B was 90 mm, the width L2 (see FIG. 2, FIG. 6) of non-emission section 32 was 10 mm, and the vertex angle 8 (see FIG. 2, FIG. 6) of reflective member 20 formed between reflective surfaces 21 and 22 of reflective member 20 was 50°. Reflective member 20 was fabricated using high-brightness reflective aluminum with the reflectivity of reflective surfaces 21, 22 of about 95%.

FIG. 7 shows the properties of diffusion sheets A to C used as diffusion sheet 43 of first diffusion plate 41 and diffusion sheet 44 of second diffusion plate 42 in Examples 1 to 5. The kinds (combinations) of diffusion sheet 43 of first diffusion plate 41 and second diffusion sheet 44 of second diffusion plate 42 used in Examples 1 to 5 are as shown in FIG. 8. FIG. 8 also shows the distance L3 (see FIG. 2) between first diffusion plate 41 and light-emitting panels 10A, 10B. FIG. 8 also shows the distance L4 (see FIG. 2) between second diffusion plate 42 and light-emitting panels 10A, 10B.

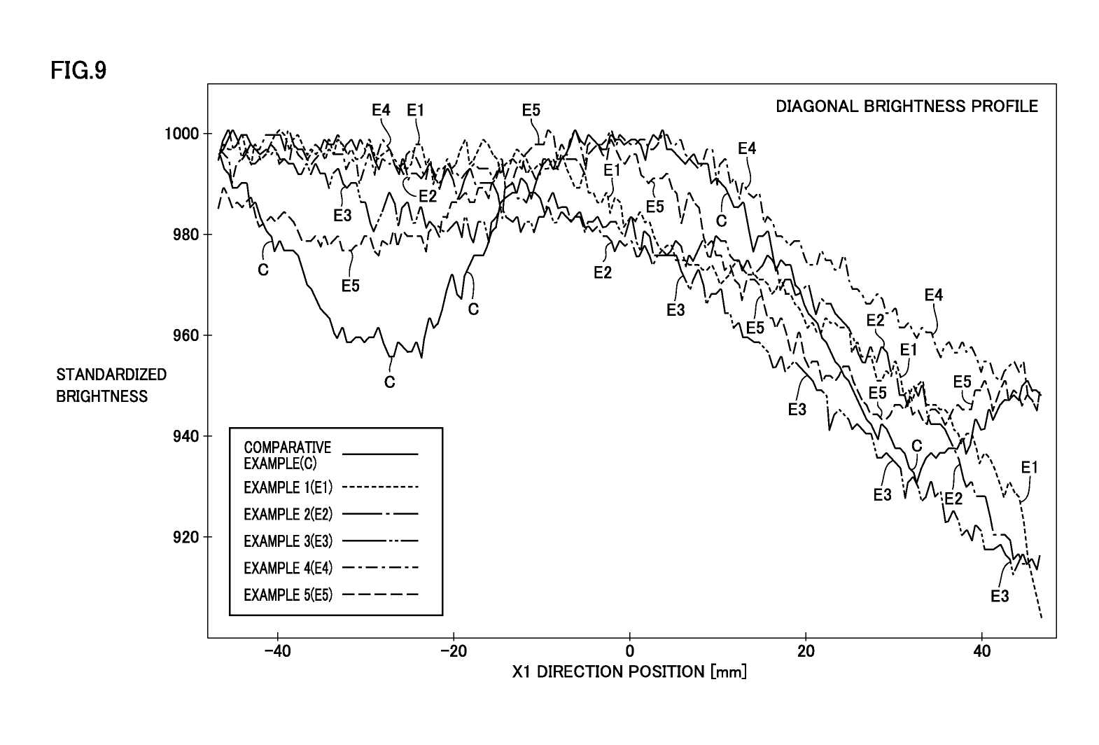

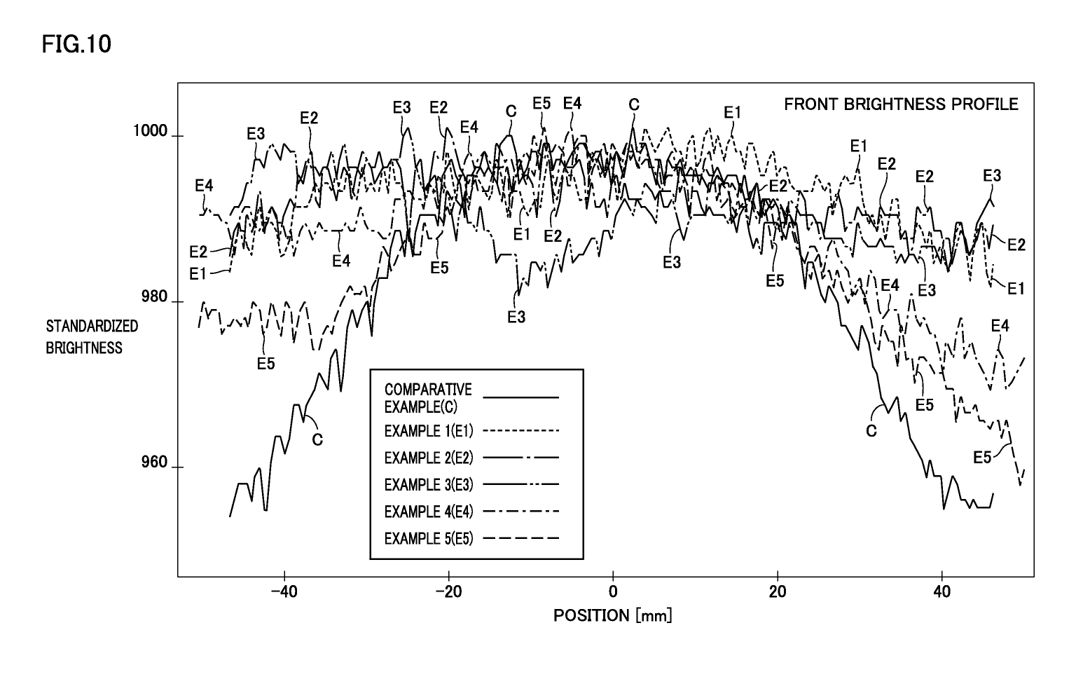

In the experimental examples, the diagonal brightness profile (see FIG. 9) and the front brightness profile (see FIG. 10) were measured for each of the surface light-emitting units based on Comparative Example and Examples 1 to 5. As for the diagonal brightness profile, the brightness of light directed toward the diagonal front direction by the angle α (=60°) (see FIG. 6) in the direction away from the surface light-emitting unit with respect to a reference line that is the direction vertical to light-emitting panels 10A, 10B was measured using a detector for each point positioned along the direction of the arrow X1 in FIG. 6. The direction of the arrow X1 extends in the direction orthogonal to the line that defines the angle α.

### (Diagonal Brightness Profile)

FIG. 9 is a graph showing diagonal brightness profiles of the surface light-emitting units in Comparative Example and Examples 1 to 5. The graph (the lines C, E1 to E5) shows relative values obtained by standardizing the brightness at the brightest place in each graph line to 1000. The diagonal brightness profile of surface light-emitting unit 2 according to Comparative Example is shown as the line C. The diagonal brightness profiles of the surface light-emitting units according to Examples 1 to 5 are shown as the lines E1 to E5.

Referring to the line C in FIG. 9, in the surface light-emitting unit according to Comparative Example, the standardized brightness abruptly decreases in the vicinity of the position −30 mm and in the vicinity of the position +30 mm. The standardized brightness of the surface light-emitting unit according to Comparative Example approximately exhibits the shape of a letter W as a whole.

Referring to the lines E1 to E5 in FIG. 9, it can be understood that in the surface light-emitting units according to Examples 1 to 5, the standardized brightness changes generally gently, and the standardized brightness mildly decreases from the position −40 mm toward the position +40 mm. In the surface light-emitting units according to Examples 1 to 5, the non-uniformity of brightness can be reduced when compared with the profile obtained from the surface light-emitting unit according to Comparative Example.

It can be understood that the rate of decrease of the brightness decreasing from the position −40 mm toward the position +40 mm in the configurations according to Examples 1, 2, 4, and 5 (the lines E1, E2, E4, E5) is smaller than the rate of decrease in the configuration according to Example 3 (the line E3). The rate of decrease is smallest in the configuration according to Example 4 (the line E4) among Examples 1, 2, 4, and 5.

Examples 1, 2, 4, and 5 have such a configuration that the transmittance of first diffusion plate 41 (diffusion sheet 43) is higher than the transmittance of second diffusion plate 42 (diffusion sheet 44), whereas Example 3 has a reversed configuration. It can be understood that the configuration in which the transmittance of first diffusion plate 41 (diffusion sheet 43) is higher than the transmittance of second diffusion plate 42 (diffusion sheet 44) can be employed to reduce the rate of decrease of the brightness decreasing from the position −40 mm toward the position +40 mm.

### (Front Brightness Profile)

FIG. 10 is a graph showing the front brightness profiles of the surface light-emitting units according to Comparative Example and Examples 1 to 5. The graph (the lines C, E1 to E5) shows relative values obtained by standardizing the brightness at the brightest place in each graph line to 1000. The front brightness profile of surface light-emitting unit 2 according to Comparative Example is shown as the line C. The front brightness profiles of the surface light-emitting units according to Examples 1 to 5 are shown as the lines E1 to E5.

Referring to FIG. 10, among Comparative Example and Examples 1 to 5, the configuration according to Comparative Example (the line C) has the largest variations in brightness (distribution in the vertical direction in the graph). In the surface light-emitting units according to Examples 1 to 5, the non-uniformity of brightness can be reduced also in the front brightness profile when compared with the profile obtained from the surface light-emitting unit according to Comparative Example.

Based on those results, it can be understood that the configuration of the surface light-emitting unit in the embodiment of the present invention as described above provides the brightness profile with reduced variations in brightness distribution not only in the front direction but also in the diagonal direction, resulting in a surface light-emitting unit with reduced non-uniformity of brightness and with more inconspicuous non-emission section.

In the description of the embodiment of the present invention described above, the reflective member is arranged so as to extend over the main surfaces of the adjacent light-emitting panels, by way of example. However, the reflective member may be arranged so as to fit in the gap formed between the adjacent light-emitting panels. In this case, it is necessary that at least part of the front end side of the reflective member is arranged so as to be positioned on the diffusion plate side with respect to the main surface of the light-emitting panel.

The surface light-emitting unit to which the present invention is applied is not limited to lighting systems in a narrow sense in indoor or outdoor lighting applications. The surface light-emitting unit to which the present invention is applied embraces lighting systems in a broad sense provided in, for example, displays, display devices, and lighting display signs and advertisements.

The surface light-emitting unit as described above includes a plurality of light-emitting panels arranged side by side in a planar state, a reflective member having a shape extending along outer edges of the light-emitting panels adjacent to each other among a plurality of the light-emitting panels for reflecting part of light emitted from a plurality of the light-emitting panels toward a front side, a first diffusion layer arranged to be opposed to a plurality of the light-emitting panels and the reflective member at a distance therefrom for diffusing light emitted from a plurality of the light-emitting panels and light reflected by the reflective member, and a second diffusion layer positioned on the opposite side to a plurality of the light-emitting panels as viewed from the first diffusion layer and arranged at a distance from the first diffusion layer for diffusing light from the first diffusion layer.

Preferably, the transmittance of the first diffusion layer is higher than the transmittance of the second diffusion layer. Preferably, the Haze values of the first diffusion layer and the second diffusion layer are 90% or more. The first diffusion layer and the second diffusion layer can be configured integrally with a transparent layer interposed. In this case, the transparent layer may be formed with a transparent substrate, the first diffusion layer may be arranged on one surface of the transparent substrate, and the second diffusion layer may be arranged on the other surface of the transparent substrate. Alternatively, the first diffusion layer and the second diffusion layer may be provided such that a transparent layer is interposed therebetween, and at least one of the first diffusion layer and the second diffusion layer may be formed so as to impart light diffusivity to a surface of a transparent substrate, so that the at least one of the first diffusion layer and the second diffusion layer is integrally formed with the transparent layer.

These configurations can be employed to even further reduce the non-uniformity of brightness.

Although the embodiments and examples based on the present invention have been described above, the embodiment disclosed here should be understood as being illustrative rather than being limitative in all respects. The technical scope of the present invention is shown in the claims, and it is intended that all modifications that come within the meaning and range of equivalence to the claims are embraced here.

1. A surface light-emitting unit comprising:
a plurality of light-emitting panels arranged side by side in a planar state;
a reflective member having a shape extending along outer edges of the light-emitting panels adjacent to each other among a plurality of the light-emitting panels for reflecting part of light emitted from a plurality of the light-emitting panels toward a front side;
a first diffusion layer arranged so as to be opposed to a plurality of the light-emitting panels and the reflective member at a distance therefrom for diffusing light emitted from a plurality of the light-emitting panels and light reflected by the reflective member; and
a second diffusion layer positioned on an opposite side to a plurality of the light-emitting panels as viewed from the first diffusion layer and arranged at a distance from the first diffusion layer for diffusing light from the first diffusion layer.

2. The surface light-emitting unit according to claim 1, wherein a transmittance of the first diffusion layer is higher than a transmittance of the second diffusion layer.

3. The surface light-emitting unit according to claim 1, wherein Haze values of the first diffusion layer and the second diffusion layer are 90% or more.

4. The surface light-emitting unit according to claim 1, wherein the first diffusion layer and the second diffusion layer are integrally configured with a transparent layer interposed.

5. The surface light-emitting unit according to claim 4, wherein
the transparent layer is configured with a transparent substrate,
the first diffusion layer is arranged on one surface of the transparent substrate, and
the second diffusion layer is arranged on the other surface of the transparent substrate.

6. The surface light-emitting unit according to claim 1, wherein
the first diffusion layer and the second diffusion layer are provided such that a transparent layer is interposed therebetween, and
at least one of the first diffusion layer and the second diffusion layer is formed so as to impart light diffusivity to a surface of a transparent substrate, so that at least the one of the first diffusion layer and the second diffusion layer is integrally formed with the transparent layer.

7. The surface light-emitting unit according to claim 2, wherein Haze values of the first diffusion layer and the second diffusion layer are 90% or more.
